(19) United States
(12) Patent Application Publication
(10) Pub. No.: US 2008/0120272 A1
(43) Pub. Date: May 22, 2008

(54) EXTRAPOLATING FROM DATE STATISTICS

(76) Inventor: Paul Sinclair, Manhattan Beach, CA (US)

Correspondence Address: John D. Cowart;Intellectual Property Section, NRC Corporation, 1700 South Patterson Blvd., Dayton, OH, 45479-0001, US

(21) Appl. No.: 11/561,511

(22) Filed: Nov. 20, 2006

(51) Int. Cl. G06F 17/30

(52) U.S. Cl. 707/2; 707/E17.14

(57) ABSTRACT

A database system extrapolates from date statistics maintained on a table in the system. In doing so, the system receives at a current date a date value in relation to which statistics are required, calculates a highest date for the date statistics, and compares the date value with the highest date. If the date value is greater than the highest date, then the system repeatedly reduces the date value by a fixed time period until the date value is less than or equal to the highest date. The system then calculates cardinality and number of unique values based on the reduced data value.

### BACKGROUND

Computer systems generally include one or more processors interfaced to a temporary data storage device such as a memory device and one or more persistent data storage devices such as disk drives. Data is usually transferred between the memory device and the disk drives over a communications bus or similar. Once data has been transferred from the disk drive to a memory device accessible by a processor, database software is then able to examine the data to determine if it satisfies the conditions of a query.

Queries issued to the database system may be processed with a multitude of possible execution plans. Some execution plans are more cost efficient than other execution plans based on several factors including the number and size of intermediate result sets required to be constructed. Some queries are able to undergo query optimization that can enable dramatic improvements in performance in such database systems. A cost based query optimizer evaluates some or all possible execution plans for a query and estimates the cost of each plan based on resource utilization. The optimizer eliminates costly plans and chooses a relatively low cost plan.

Inputs to the optimizer include demographic statistics in the form of histograms about the tables referenced in the query. A user requests the system to collect statistics on a column of table. The system collects statistics for a column by scanning all or a sample of the rows and aggregating the information to build a histogram. Once statistics are collected on a column with a date data type, the statistics can become stale very quickly as new data is loaded. For example, when the data for a new day is loaded, the statistics, if not recollected, would indicate there are no rows for that day. This may lead the optimizer to choose a plan that is efficient for a few rows but is much less efficient than some other plan that is able to handle the larger number of rows actually now in the table for that date. The optimizer assumes a minimum of one row even if the statistics indicate there are zero rows in the range.

The cost to recollect statistics has the potential to be very large since the statistics are collected against all the data and not just the incremental additional data. Collecting statistics has not been a major issue in the past when data was loaded in batches once a month or weekly. As data freshness requirements have become more demanding, statistics need to be collected more frequently. However, collecting statistics on a daily or more frequent basis can be cost prohibitive.

### SUMMARY

Described below are methods for extrapolating from date statistics maintained on a table in a database system. The statistics are grouped into a plurality of ordered intervals based on a date-time stamp value representing the data value in the date data type column in the respective rows of the table. A plurality of the intervals include a max value representing the maximum date-time stamp value in the rows of the table represented by the interval. At least one of the intervals includes a collection date representing the date the statistics were collected, and at least the last interval includes a mode value representing the most frequently occurring date-time stamp value in the rows of the table represented by the interval.

The table has at least one column with a date data type. The method includes the step of receiving at a current date a date value in relation to which statistics are required. The date value is then compared with the highest date in the date statistics. If the date value is greater than the highest date, then the date value is repeatedly reduced by a fixed time period until the date value is less than or equal to the highest date. The cardinality and number of unique values are then calculated based on the reduced data value. Also described below is a method of handling a date range.

There are several techniques described below to determine the highest date in the date statistics.

Also described below is a method of optimizing queries to a database system comprising tables of data stored on one or more storage facilities and managed by one or more processing units. The method includes the step of receiving a user query having a plurality of potential execution plans. The cost of one or more of the potential execution plans is estimated based at least partly on information extrapolated from the statistics by one of the methods described below. An execution plan is then selected from the potential execution plans based at least partly on the estimated cost of one or more of the potential execution plans.

### BRIEF DESCRIPTION OF THE DRAWINGS

FIG. 1 is a block diagram of an exemplary large computer system in which the techniques described below are implemented.

FIG. 2 is a block diagram of the parsing engine of the computer system of FIG. 1.

FIG. 3 is a flow chart of the parser of FIG. 2.

FIG. 4 is a diagram of a table on which statistics are collected.

FIG. 5 is a diagram of statistics collected on the table of FIG. 4.

FIG. 6 is a flow chart of a technique for extrapolating date statistics.

### DETAILED DESCRIPTION

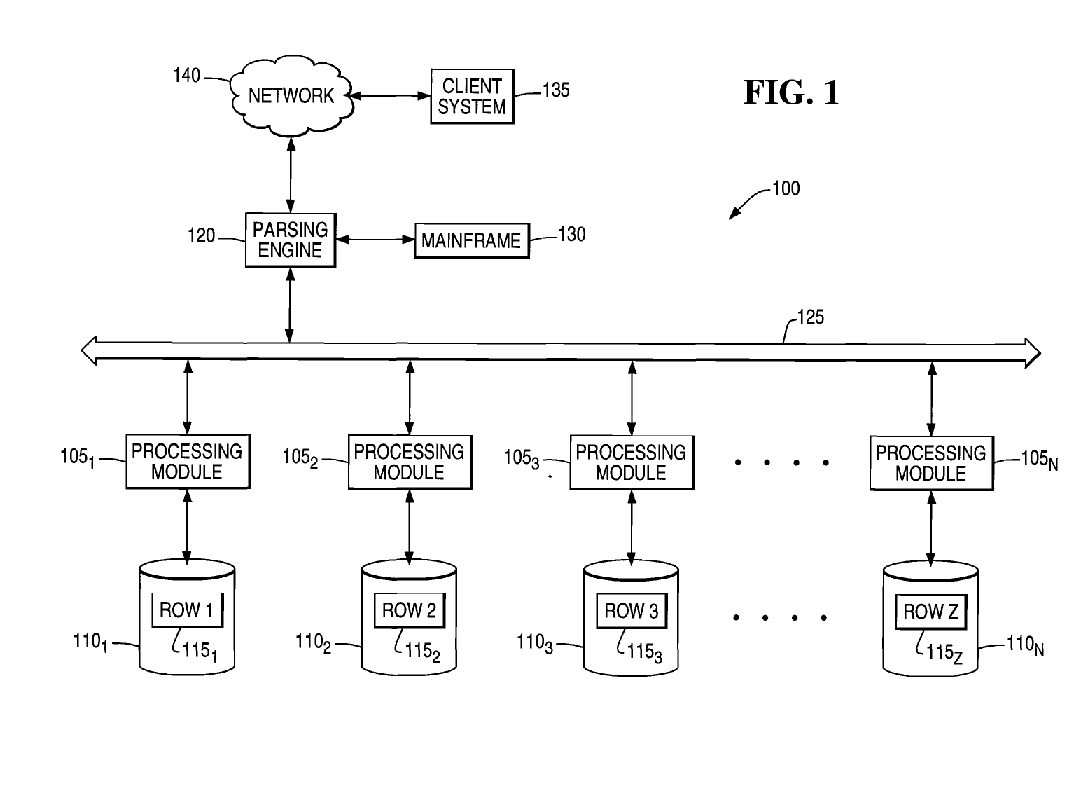

FIG. 1 shows an example of a database system 100, such as a Teradata Active Data Warehousing System available from NCR Corporation. Database system 100 is an example of one type of computer system in which the techniques of aging and recollecting statistics are implemented. In computer system 100, vast amounts of data are stored on many disk-storage facilities that are managed by many processing units. In this example the data warehouse 100 includes a Relational Database Management System (RDMS) built upon a Massively Parallel Processing (MPP) platform.

Other types of database systems, such as object-relational database management systems (ORDMS) or those built on symmetric multi-processing (SMP) platforms, are also suited for use here.

The database system 100 includes one or more processing modules 105_{1 . . . N} that manage the storage and retrieval of data in data storage facilities 110_{1 . . . N}. Each of the processing modules 105_{1 . . . N} manages a portion of a database that is stored in a corresponding one of the data storage facilities 110_{1 . . . N}. Each of the data storage facilities 110_{1 . . . N} includes one or more disk drives.

The system stores data in one or more tables in the data storage facilities 110_{1 . . . N}. The rows 115_{1 . . . Z} of the tables are stored across multiple data storage facilities 110_{1 . . . N} to ensure that the system workload is distributed evenly across the processing modules 105_{1 . . . N}. A parsing engine 120 organizes the storage of data and the distribution of table rows 115_{1 . . . Z} among the processing modules 105_{1 . . . N}. The parsing engine 120 also coordinates the retrieval of data from the data storage facilities 110_{1 . . . N} over network 125 in response to queries received from a user at a mainframe 130 or a client computer 135 connected to a network 140. The database system 100 usually receives queries and commands to build tables in a standard format, such as SQL.

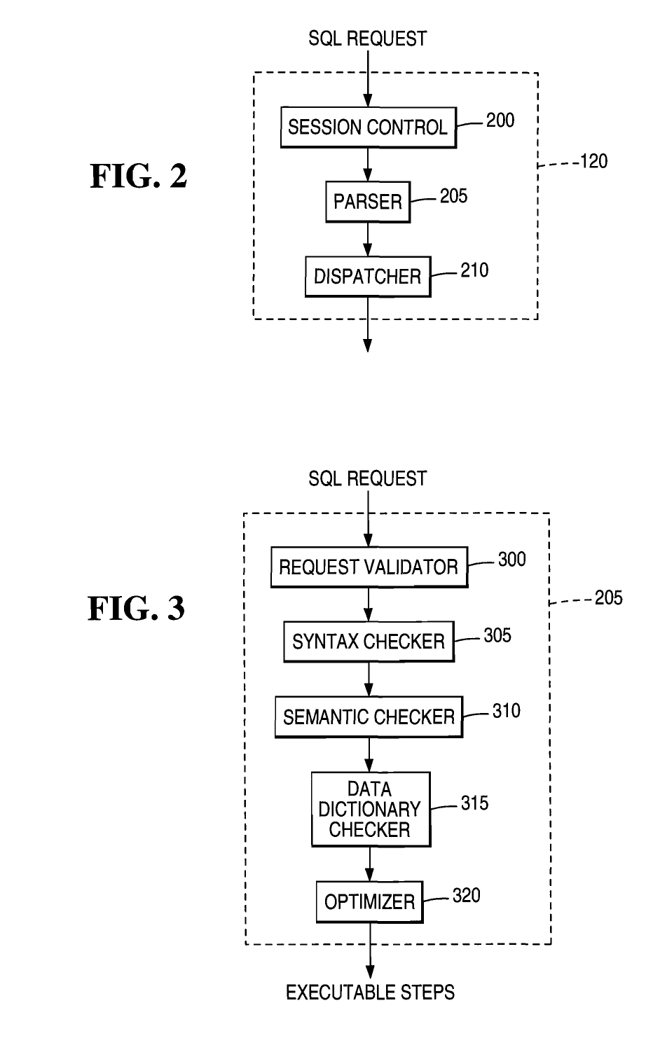

In one example system, the parsing engine 120 is made up of three components: a session control 200, a parser 205, and a dispatcher 210, as shown in FIG. 2. The session control 200 provides a log on and log off function. It accepts a request for authorization to access the database, verifies it, and then either allows or disallows the access.

Once the session control 200 allows a session to begin, a user may submit a SQL request, which is routed to the parser 205. As illustrated in FIG. 3, the parser 205 validates the SQL request (block 300), checks it for proper SQL syntax (block 305), evaluates it semantically (block 310), and consults a data dictionary to ensure that all of the objects specified in the SQL request actually exist and the user has the authority to perform the request (block 315). Finally, the parser 205 runs an optimizer (block 320) which develops the least expensive plan to perform the request.

The optimizer has access to statistics that were previously requested by the user to be collected on one or more of the tables stored on data storage facilities 110.

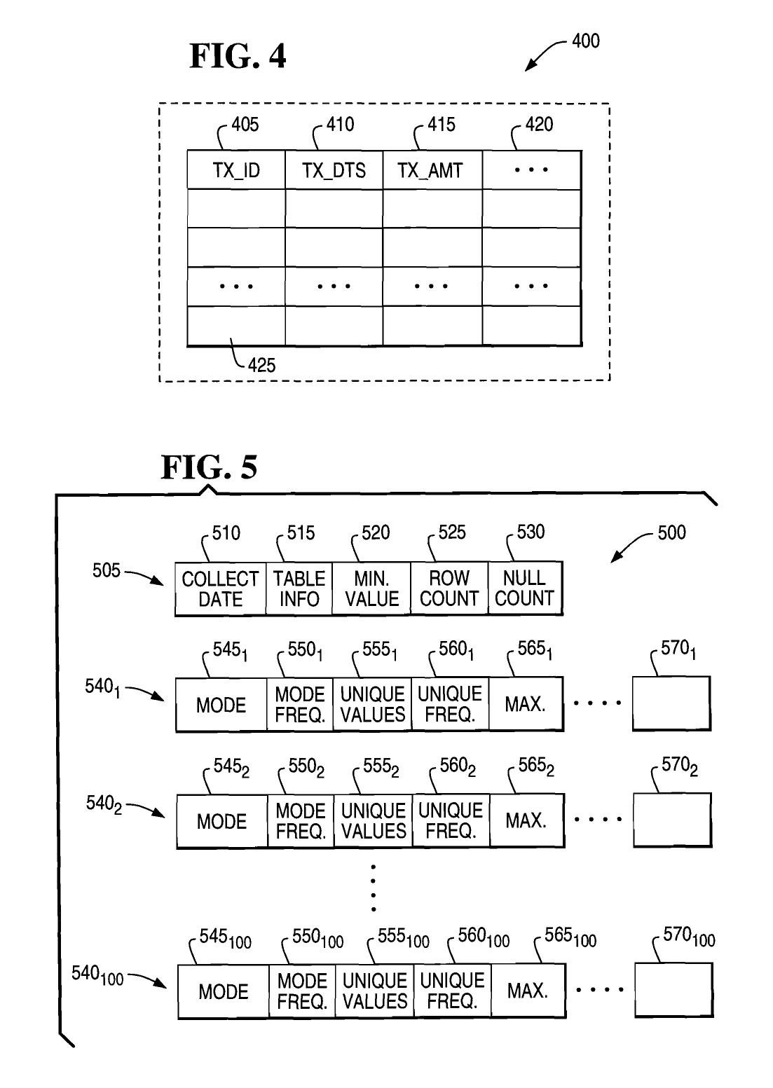

FIG. 4 illustrates a typical table 400 on which statistics have been collected. Database table 400 is an example of transaction data. Transaction data typically records transactional events that are routine in the life of a business such as retail purchases by customers, call-detail records, bank deposits, bank withdrawals and insurance claims. Table 400 includes a transaction identifier (TX_ID, column 405), a transaction date-time stamp indicating when a particular transaction took place (TX_DTS, column 410) and the value or amount of the transaction (TX_AMT, column 415). The table 400 could include further columns 420.

The number of rows in a transaction table such as table 400 in a typical organization is likely to be very large. The number of rows, each row representing a different transaction, could be many millions or billions. Users tend to maintain a greater number of statistics on larger tables such as table 400 so as to improve plan selection by the optimizer.

Some implementations involving a table similar to table 400 include a marker row 425. The marker row 425 is intended to designate the “last” row in a table. The marker row 425 for example would have a very high date-time stamp value that exceeds the other date/time stamp values in the remaining rows, any date/time stamp values expected to be entered in the future, and any date/time stamp values anticipated in a user query.

At the request of a user, statistics are generated from table 400. In FIG. 5 the statistics 500 are collected on column 410. The rows in the table 400 are first sorted by date-time stamp value and the minimum value is recorded in the statistics. The rows are then grouped into a plurality of ordered intervals based on the date-time stamp value in each row. Typically, there are 100 groups or intervals and each group or interval has approximately the same number of rows. Various statistics are calculated, for example, the mode of each interval representing the date-time stamp value that occurs most frequently within an interval.

As part of statistics collection, statistics 500 are typically stored in a data dictionary. The statistics include an initial interval 505 which is also referred to as interval 0. Interval 0 includes basic or general information about the table and includes, for example, a collection date 510 representing the date the statistics were collected, general table information 515, a minimum value 520 representing the smallest date-time stamp value in column 410 table 400, a row count 525 representing the total count or number of rows in table 400 and a null count 530 representing the total number of null values in the table 400.

Following interval 0 is data representing each of the 100 intervals, indicated as 540₁, 540₂ and so on to 540₁₀₀. Each interval 540_{1 . . . 100} in turn includes the mode value 545_{1 . . . 100} representing the most frequently occurring date-time stamp value in that interval and the number or frequency 550_{1 . . . 100} of those occurrences, the number of other unique values 555_{1 . . . 100} in that interval, the total number 560_{1 . . . 100} of those occurrences, and the max value 565_{1 . . . 100} representing the highest date-time stamp value in that interval. It will be appreciated that these statistics 500 in some circumstances include other statistical data 570_{1 . . . 100} depending on the purpose for which the statistics are collected.

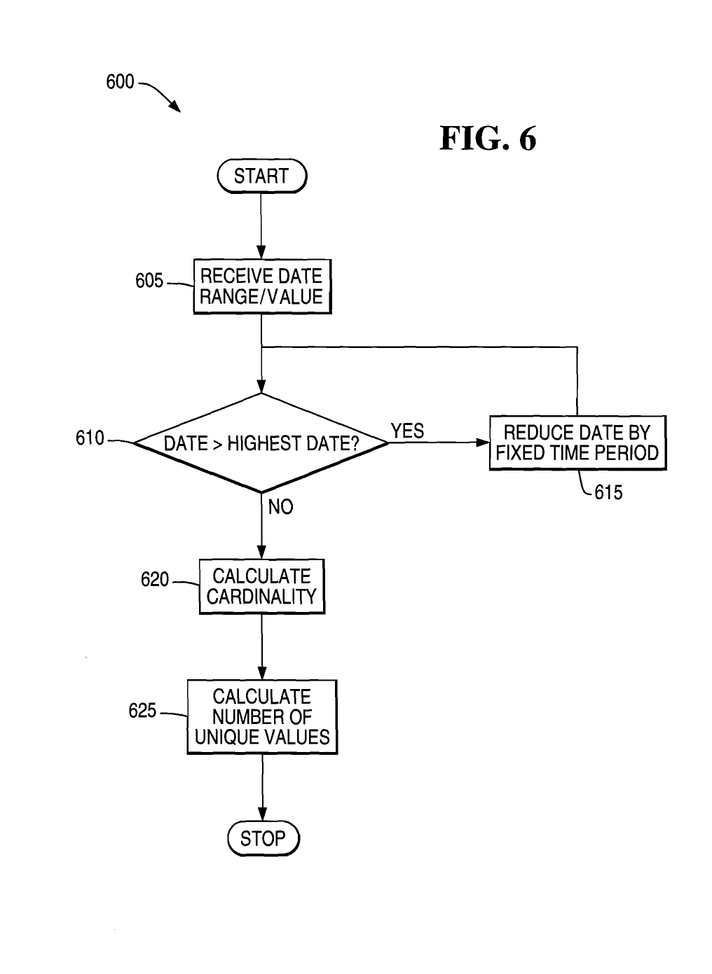

FIG. 6 shows a flow chart of a technique for extrapolating date statistics. The technique 600 starts with a date range or date value being received 605. The date range or date value is generally part of a user query and the optimizer checks statistics maintained on the tables referenced in the query in order to optimize execution of the query. The date received could be a particular date value or could involve a date range having two date values, a start date representing the lower end of the date range and an end date representing the higher end of the date range. The received date has an associated current date representing the date at which the received date was received.

As described above, the statistics maintained on the table have associated date information. The statistics include a date value representing the date at which the data was collected and statistics were generated. The dates could also represent the date data in the table on which the statistics have been generated.

The highest date for the stored statistics is compared with the date range or value received 610. In the statistics described above, in one technique the highest date is the max value 565₁₀₀ in interval 540₁₀₀ or the last interval if there are fewer than 100 intervals.

For the purposes of determining the highest date, a second technique is the same as the first except the highest date is the max value from the penultimate interval in the date statistics if the max of the last interval is greater than the date value or range that has been received and is also greater than the current date at which the query was received.

For the purposes of determining the highest date, an alternative third technique is preferably the same as the second except the highest date is the date the statistics were collected if the max of the actual last interval is greater than the date value or range that has been received and is greater than the current date at which the query was received, and also the date the statistics were collected is greater than the mode value of the actual last interval. For this case, the date the statistics were collected is used instead of the max of the last interval if this max is used in the extrapolation below. In other words, the max value of the last interval is reduced to the value of the collection date. Also for this case, the number of other unique values in the last interval and the total number of those occurrences are both reduced by one if used in the extrapolation below.

The second and third techniques described above therefore avoid spurious data caused by the inclusion of a marker row 405 in table 400 above. The second technique is well-suited to an implementation of collecting statistics where values outside the normal distribution are separated out into their own intervals.

In the case of a date value, if the date value is greater than the highest date as determined by using one of the techniques above, the value of the received date is reduced 615 by a fixed time period. This fixed time period in one form is 1 week. In other forms of the technique the fixed time period is 52 weeks, 3 months and 1 year respectively. The reduced date is then compared with the highest date in the date statistics. If the reduced date is still higher than the highest date then the date is further reduced by the same fixed time period. The received date value is repeatedly reduced by the same fixed time period until the date value is less than or equal to the highest date.

Where the received date is a date range both the minimum and maximum date values in the range are reduced by the same fixed time period until the maximum date value in the range is less than or equal to the highest date in the date statistics.

It will be appreciated that the above technique effectively maps a received date or date range to a new date value or date range that is within a date range for which statistics have been gathered.

Following the mapping, estimates of the cardinality 620, number of unique values 625, and other information for costing plans can be calculated as usual from the intervals that overlap the mapped date or date range. These values are then used as usual to compute the estimated cost of a plan and then to compare this plan cost to the cost of other possible plans allowing the optimizer to be able to choose the least cost plan. The above technique enables the optimizer to use the statistics that have been collected and generated from the table databases to extrapolate information about data in the table for which statistics have not been specifically collected. This information includes the cardinality and number of unique values, and further includes other types of information common to statistical data techniques.

The technique effectively reduces or maps the received date to a lower date within the collected statistics. It will be appreciated that the received date could be maintained unaltered and a copy or another variable set to the same value as the received date and that other variable reduced by step 615.

The technique in one form also checks the cardinality for one or more additional previous time periods. The technique could be repeated for example to generate an additional date value that is one week further back than the highest date in the statistics. Similarly additional time periods would include 52 weeks, 3 months and 1 year. It will be appreciated that similar checks could be done for the other information calculated from the statistics.

It is anticipated that the highest estimate of table cardinality would be selected to provide a conservative estimate for the query optimizer. It will be further envisaged that the statistics will be valid for a particular date range and this date range will be specified by a minimum and a maximum date.

The cardinality, number of unique values, and other information generated by the above technique of extrapolating date statistics is then used for optimizing queries. The user query is received that has a plurality of potential execution plans. The cost of one or more of those potential execution plans is then estimated based at least partly on the cardinality, number of unique values and the other information generated by the above techniques. An execution plan is then selected from the potential execution plans based at least partly on estimated cost of one or more of these potential execution plans.

The above techniques provide an efficient way to estimate the cardinality of rows in a range beyond the range of the collected statistics. By going back in fixed increments of weeks for example, corresponding days of the week are selected. Checking multiple periods has the potential to avoid problems with holidays and other events that may result in statistics that are different than normal. Furthermore, picking a highest value for table cardinality leads to a more conservative estimate that will help to avoid bad plans and potentially result in a good if not optimal plan.

More sophisticated extrapolation, such as a forecasting technique of analyzing the statistics to predict future statistics are possible but are expected to be more costly to compute. When the data is consistent with these heuristics, the above techniques are expected to work well and alleviate the need to recollect statistics as often. In other cases, the user still has the option to recollect statistics, drop statistics, use sample statistics, or use some other technique.

The text above describes one or more specific embodiments of a broader invention. The invention also is carried out in a variety of alternative embodiments and thus is not limited to those described here. Those other embodiments are also within the scope of the following claims.

I claim:

1. A method for extrapolating from date statistics maintained on a table in a database system, the method comprising:
receiving at a current date a date value in relation to which statistics are required;
calculating a highest date for the date statistics;
comparing the date value with the highest date;
if the date value is greater than the highest date, then repeatedly reducing the date value by a fixed time period until the date value is less than or equal to the highest date; and
calculating cardinality, and number of unique values based on the reduced data value.

2. The method of claim 1, comprising the step of calculating the highest date as the max value of the last interval.

3. The method of claim 1, comprising the step of calculating the highest date as the max value of the penultimate interval if the max value of the last interval is greater than both the received date value and the current date.

4. The method of claim 1 further comprising the step of calculating the highest date as the collection date if the max value of the last interval is greater than both the received date value and the current date, and the collection date is greater than the mode value of the last interval.

5. The method of claim 4 wherein at least the last interval includes the max value of the interval, the method further comprising the step of reducing the max of the last interval to the collection date.

6. The method of claim 4 wherein at least the last interval includes the number of unique values other than the mode value and the number of occurrences of the unique values in the rows of the table represented by the interval, the method further comprising the step of reducing the number of other unique values in the last interval and the total number of those occurrences by one.

7. The method of claim 1 wherein the fixed time period is one week.

8. The method of claim 1 wherein the fixed time period is 52 weeks.

9. The method of claim 1 wherein the fixed time period is 3 months.

10. The method of claim 1 wherein the fixed time period is 1 year.

11. The method of claim 1 wherein the information generated includes the cardinality of data in the table specified by the date value.

12. A method for extrapolating from date statistics maintained on a table in a database system, the method comprising:
receiving at a current date a date range in relation to which statistics are required, the date range including a start date representing the lower end of the date range and an end date representing the higher end of the date range;
calculating a highest date in the date statistics;
comparing the end date with the highest date;
if the end date is greater than the highest date, then repeatedly reducing the start date and the end date by a fixed time period until the end date is less than or equal to the highest date; and
calculating cardinality and number of unique values based on the reduced date range.

13. The method of claim 12, comprising the step of calculating the highest date as the max value of the last interval.

14. The method of claim 12, comprising the step of calculating the highest date as the max value of the penultimate interval if the max value of the last interval is greater than both the received date value and the current date.

15. The method of claim 12 further comprising the step of calculating the highest date as the collection date if the max value of the last interval is greater than both the received date value and the current date, and the collection date is greater than the mode value of the last interval.

16. The method of claim 15 wherein at least the last interval includes the max value of the interval, the method further comprising the step of reducing the max of the last interval to the collection date.

17. The method of claim 15 wherein at least the last interval includes the number of unique values other than the mode value and the number of occurrences of the unique values in the rows of the table represented by the interval, the method further comprising the step of reducing the number of other unique values in the last interval and the total number of those occurrences by one.

18. The method of claim 12 wherein the fixed time period is one week.

19. The method of claim 12 wherein the fixed time period is 52 weeks.

20. The method of claim 12 wherein the fixed time period is 3 months.

21. The method of claim 12 wherein the fixed time period is 1 year.

22. The method of claim 12 wherein the information generated includes the cardinality of data in the table specified by the date value.
